(19) United States
(12) Patent Application Publication
(10) Pub. No.: US 2026/0014758 A1
(43) Pub. Date: Jan. 15, 2026

(54) SYSTEM AND METHOD FOR DYNAMICALLY CONTROLLING A THERMOSET THREE-DIMENSIONAL PRINTER TO CREATE DESIRED COLOR ATTRIBUTES

(71) Applicant: PPG Industries Ohio, Inc., Cleveland, OH (US)

(72) Inventors: Kerianne Merceline Dobosz, Pittsburgh, PA (US); Elijah Mitchel Solley, Pittsburgh, PA (US); Nicole Rose Donahue, Cranberry Township, PA (US); Francis Patrick Cassidy, Pittsburgh, PA (US); Michael Anthony Bubas, Pittsburgh, PA (US)

(21) Appl. No.: 19/262,912

(22) Filed: Jul. 8, 2025

Related U.S. Application Data
(60) Provisional application No. 63/670,306, filed on Jul. 12, 2024.

(51) Int. Cl. B29C 64/393; B29C 64/118; B29K 101/10; B33Y 50/02

(52) U.S. Cl. CPC B29C 64/393; B33Y 50/02; B29C 64/118; B29K 2101/10; B29K 2995/0021

(57) ABSTRACT

Disclosed are computer systems for color matching a printed layer of a thermoset three-dimensional printer according to a received indication of a desired final color property. A color material having a color property may be mixed with a thermoset coreactive composition such that the target object resulting from the extrusion of the thermoset coreactive composition of the thermoset three-dimensional printer obtains the desired final color property upon curing. The desired final color property may be obtained from color measurement of a reference object or may be selected by a user of the computer system. A dispensing machine may dispense and/or mix color material components according to a formulation for the desired final color property to generate a color material for mixing with the thermoset coreactive composition.

### CROSS-REFERENCE TO RELATED APPLICATIONS

This application claims the benefit of and priority to U.S. Provisional Patent Application Ser. No. 63/670,306 filed on Jul. 12, 2024 and entitled “SYSTEM AND METHOD FOR DYNAMICALLY CONTROLLING A THERMOSET THREE-DIMENSIONAL PRINTER TO CREATE DESIRED COLOR ATTRIBUTES,” which application is expressly incorporated herein by reference in its entirety.

### BACKGROUND OF THE INVENTION

### 1. Technical Field

The present disclosure relates to computer control of three-dimensional printing methods that use coreactive materials.

### 2. Background and Relevant Art

Three-dimensional (3D) printing, also referred to as additive manufacturing, has experienced a technological explosion in the last several years. This increased interest is related to the ability of 3D printing to easily manufacture a wide variety of objects from common computer-aided design (CAD) files. In 3D printing, a composition is laid down in successive layers of material to build a structure. These layers may be produced, for example, from liquid, powder, paper, or sheet material.

In conventional configurations, a 3D printing system utilizes a thermoplastic material. The 3D printing system extrudes the thermoplastic material (e.g., a thermoplastic filament) through a heated nozzle on to a platform. Using instructions derived from a CAD file, the system moves the nozzle with respect to the platform, successively building up layers of thermoplastic material to form a 3D object. After being extruded from the nozzle, the thermoplastic material cools. The resulting 3D object is thus made of layers of thermoplastic material that have been extruded in a heated form and layered on top of each other.

The 3D printing of objects having desired color attributes has been limited. In the case of thermoplastic 3D printing, the color of a printed layer is generally limited to the color of the thermoplastic material used, such that the color of a target object after printing has been limited to the thermoplastic materials generally available. In many instances where a particular color for the target object is desired additional processing, including one or more layers of a color dye and/or a spray coat, is applied to finish the appearance of the target object. However, such processes increase production time and present additional costs to the manufacturing process.

The subject matter claimed herein is not limited to systems or methods that solve any disadvantages or that operate only in environments such as those described above. Rather, this background is only provided to illustrate one exemplary technology area where some embodiments described herein may be practiced.

### BRIEF SUMMARY OF THE INVENTION

A computer system for dynamically controlling a thermoset three-dimensional printer to create desired color attributes, comprises one or more processors and one or more computer-readable media having stored thereon executable instructions that when executed by the one or more processors configure the computer system to perform various acts. The computer system may receive a color printing data packet that comprises an indication of a desired final color property of a target object to be printed. Additionally, the computer system may access a color attribute dataset that describes different color properties that result based upon different mixture configurations and/or printing configurations. Additionally, based upon the color attribute dataset, the computer system may determine a particular mixture configuration and/or printing configuration for one or more color materials in order to achieve the desired final color property of the target object. The computer system may then generate a command to cause the thermoset three-dimensional printer to implement the particular mixture configuration and/or printing configuration of the one or more thermoset materials when printing the target object.

Additionally, a computer-implemented method for dynamically controlling a thermoset three-dimensional printer to create desired color attributes may be executed on one more processors. The computer-implemented method may comprise receiving a color printing data packet that comprises an indication of a desired final material property of a target object to be printed. Additionally, the computer-implemented method may include accessing a color attribute dataset that describes different color properties that result based upon different mixture configurations and/or printing configurations. Additionally, based upon the color attribute dataset, computer-implemented method may include determining a particular mixture configuration and/or printing configuration for one or more color materials in order to achieve the desired final color property of the target object. The method may also include generating a command to cause the thermoset three-dimensional printer to implement the particular mixture configuration and/or printing configuration of the one or more thermoset materials when printing the target object.

Further, a computer-readable media may comprise one or more physical computer-readable storage media having stored thereon computer-executable instructions that, when executed at a processor, cause a computer system to perform a method for dynamically controlling a thermoset three-dimensional printer to create desired color attributes. The executed method may comprise receiving a color printing data packet that comprises an indication of a desired final material property of a target object to be printed. The executed method further comprises accessing a color attribute dataset that describes different material properties that result based upon different mixture configurations and/or printing configurations. Additionally, based upon the color attribute dataset, the executed method may include determining a particular mixture configuration and/or printing configuration for one or more color materials in order to achieve the desired final color property of the target object. Additionally, the executed method may comprise generating a command to cause a thermoset three-dimensional printer to implement the particular mixture configuration and/or printing configuration of the one or more thermoset materials when printing the target object.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description and aspects which follow, and in part will be obvious from the description, or may be learned by the practice of the teachings herein. Features and advantages of the disclosed systems, methods, and apparatuses may be realized and obtained by means of the instruments and combinations particularly pointed out in the appended claims. Features of the present systems, methods, and apparatuses will become more fully apparent from the following description, aspects, and appended claims, or may be learned by the practice of the disclosure as set forth hereinafter.

### BRIEF DESCRIPTION OF THE DRAWINGS

In order to describe the manner in which the above recited and other advantages and features of the disclosure can be obtained, a more particular description of the systems, methods, and apparatuses briefly described above will be rendered by reference to specific examples thereof, which are illustrated in the appended drawings. Understanding that these drawings depict only typical examples of the disclosure and are not therefore to be considered to be limiting of its scope, the disclosure will be described and explained with additional specificity and detail through the use of the accompanying drawings described below.

FIG. 1 illustrates an exemplary computer system comprising a computer, 3D printing design software, a thermoset 3D printer, a dispensing machine connected to the thermoset 3D printer, and a measurement device for measuring the color property of a reference object.

FIG. 2 illustrates an exemplary thermoset 3D printer for printing a target object with a color reservoir being connected to the nozzle of the thermoset 3D printer.

FIG. 3 illustrates an exemplary thermoset 3D printer configured to receive color printing data packets from a computer.

FIG. 4 illustrates an exemplary thermoset 3D printer for printing a target object wherein a color reservoir is mounted to the gantry of the thermoset 3D printer.

FIG. 5 illustrates a method for generating a command to the thermoset 3D printer for color matching to a desired final color property.

### DETAILED DESCRIPTION OF THE PREFERRED EMBODIMENTS

Disclosed are systems and methods for color matching the color properties of a three-dimensional printed target object to a desired final color property. The present disclosure extends to systems, methods, and apparatuses for dynamically controlling a thermoset three-dimensional (3D) printer. The systems, methods, and apparatuses operate through the deposition of coreactive materials during the creation of a target object. As used here, a “target object” may refer to a portion of a physical object or a complete physical object that is being additively manufactured by the systems, method, and/or apparatuses described here. Additionally, as used herein thermoset materials may comprise coreactive materials.

Additive manufacturing using coreactive components (i.e., coreactive materials) has several advantages compared to alternative additive manufacturing methods. As used herein, “additive manufacturing” refers to the use of computer-aided design (e.g., through user generated files or 3D object scanners) to cause an additive manufacturing apparatus to deposit material, layer upon layer, in precise geometric shapes. Additive manufacturing using coreactive components can create stronger parts because the materials forming successive layers can be coreacted to form covalent bonds between the layers. Also, because the components have a low viscosity when mixed, higher filler content can be used. The higher filler content can be used to modify the mechanical and/or electrical properties of the materials and the built target object. Coreactive components can extend the chemistries used in additively manufactured parts to provide improved properties such as (but not limited to) solvent resistance, abrasion resistance, Young's modulus, electrical, tensile, hardness, smoothness, and thermal resistance.

Additionally, the ability to use a computer system to control the use of coreactive components within an additive manufacturing environment provides several advantages. For example, the computer system is able to dynamically control and adjust the flow rates and tool paths of the coreactive components in ways that produce desired physical attributes of the resulting material. Such adjustments and control provide unique advantages within additive manufacturing.

For purposes of the following detailed description, it is to be understood that the disclosed systems, methods, and apparatuses may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Separate features and components of any example described herein may be combined with features and components of any other example. Additionally, features having similar reference numbers may have the same or similar characteristics.

Also, it should be understood that any numerical range recited herein is intended to comprise all sub-ranges subsumed therein. For example, a range of “1 to 10” is intended to comprise all sub-ranges between (and including) the recited minimum value of 1 and the recited maximum value of 10, that is, having a minimum value equal to or greater than 1 and a maximum value of equal to or less than 10.

The use of the singular comprises the plural and plural encompasses singular, unless specifically stated otherwise. In addition, the use of “or” means “and/or” unless specifically stated otherwise, even though “and/or” may be explicitly used in certain instances. The terms “comprising” and/or “comprise(s)” can also be substituted with the terms “consisting of” and/or “consist(s) of.”

The term “polymer” is meant to comprise prepolymer, homopolymer, copolymer, and oligomer.

The term “color material” is meant to refer to materials that provide a color to a coreactive composition and may comprise colorants, pigments (including organic, metallic, or mineral compounds), dyes (natural or synthetic), plant extracts, tints, stains, inks, paints, toners, powders, binders, fillers, stabilizers (e.g., resins), additives, primers, effect pigments (e.g., mica or silica flakes), or other material used for imparting color. For example, the color material may also include Delfleet® toners as sold by PPG Industries, Inc.

The term “mixture configuration” are meant to comprise thermoset materials used in specific quantities and ratios and color materials used in specific quantities and ratios, which may be mixed to form a coreactive composition.

The term “printing configuration” are meant to comprise the mixture configuration as well as configurations for mixing and extruding the coreactive composition, including components of a thermoset 3D printer configured to achieve the mixing and/or extruding compositions (e.g., the type of nozzle, printer head, or mixing apparatus employed), and other physical properties of the coreactive composition, including color properties, viscosity, temperature, et cetera.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

Configurations of the present disclosure are directed to the production of structural objects using liquid-based 3D printing technology. A 3D object may be produced by forming successive portions or layers of an object by depositing at least two coreactive components onto a substrate and thereafter depositing additional portions or layers of the object over the underlying deposited portion or layer. Layers are successively deposited to build the 3D printed object. The coreactive components can be mixed and then deposited or can be deposited separately. When deposited separately, the components can be deposited simultaneously, sequentially, or both simultaneously and sequentially.

Deposition and similar terms refer to the application of a printing material comprising a coreactivating or coreactive composition and/or its reactive components onto a substrate (for a first portion of the object) or onto previously deposited portions or layers of the object. Each coreactive component may comprise monomers, prepolymers, adducts, polymers, and/or crosslinking agents, which can chemically react with the constituents of the other coreactive component.

The at least two coreactive components may be mixed together and subsequently deposited as a mixture of coreactive components that react to form portions of the object. For example, the two coreactive components may be mixed together and deposited as a mixture of coreactive components that react to form the coreactivating composition by delivery of at least two separate streams of the coreactive components into a mixing apparatus such as a static mixer to produce a single stream that is then deposited. The coreactive components may be at least partially reacted by the time a coreactive composition comprising the coreactive components is deposited. The deposited coreactive composition may react at least in part after deposition and may also react with previously deposited portions and/or subsequently deposited portions of the object such as underlying layers or overlying layers of the object.

Alternatively, the two coreactive components may be deposited separately from each other to react upon deposition to form the portions of the object. For example, the two coreactive components may be deposited separately such as by using an inkjet printing system whereby the coreactive components are deposited overlying each other and/or adjacent to each other in sufficient proximity so the two reactive components may react to form the portions of the object. As another example, in an extrusion, rather than being homogeneous, a cross-sectional profile of the extrusion may be inhomogeneous such that different portions of the cross-sectional profile may have one of the two coreactive components and/or may contain a mixture of the two coreactive components in a different molar and/or equivalents ratio.

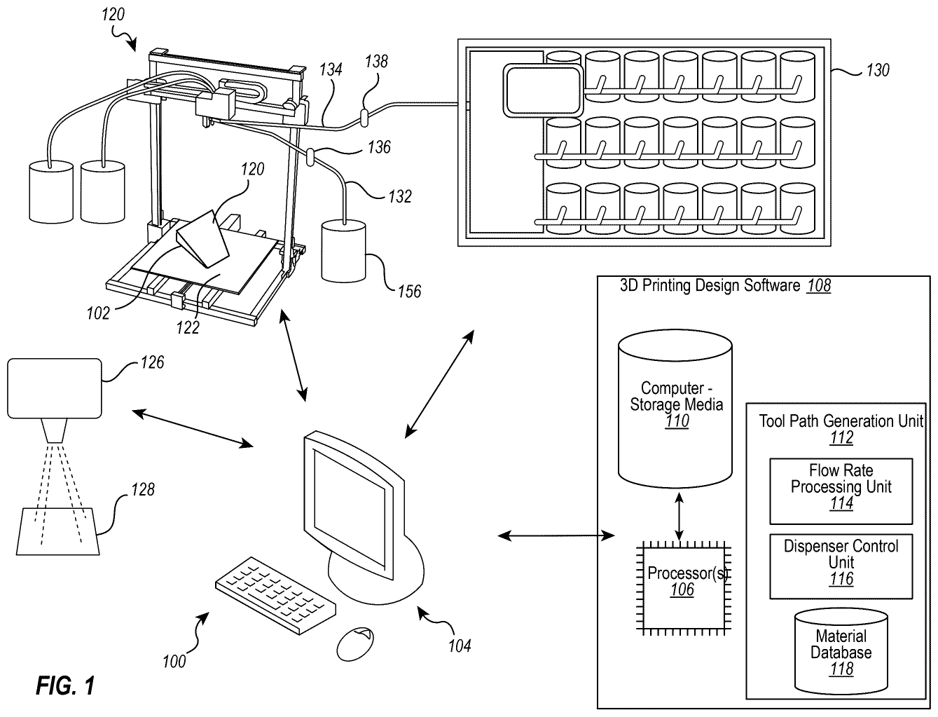

FIG. 1 illustrates an exemplary computer system 100 for color matching the color property of a target object 102 to a desired final color property. The system 100 may comprise a computer 104 having one or more processors 106 and 3D printing design software 108 stored on computer-readable media 110. The system 100 may also comprise a thermoset 3D printer 120 configured to receive commands from the computer 104 to print or generate a target object 102. The thermoset 3D printer 120 may comprise a platform 122 onto which a thermoset material, comprising first and second coreactive components, is extruded through a nozzle 124. The command may comprise the amount and ratios of thermoset materials and color materials to be mixed and extruded over the platform 122 or underlying layer of the target object 102 as well as the locations of said platform 122 or underlying layer of the target object 102 over which a coreactive composition is to be extruded.

The first and second coreactive components are mixed to form the coreactive composition a short distance before extrusion so that the formed coreactive composition may be extruded quickly after mixing the first and second coreactive components and before complete cross-linking between the first and second components occurs. This ensures that the coreactive composition may be printed in a layer of the desired shape before cross-linking completes, and the layer is cured. The thermoset materials of the coreactive composition may include (but are not limited to) polyurea, polyurethane, a Michael Addition donor (e.g., an enolate) and/or acceptor (e.g., an α,β-unsaturated carbonyl), polysulfide, polythioether, Epoxy-Amine, Aza Michael Addition donor (e.g., a nitrogen nucleophile) and/or acceptor, and/or thiolene. The thermoset materials, in liquid form, may be water air tight and may also be employed to print a target object 102 which is water tight and/or air tight. Printing of the thermoset materials may be performed at ambient temperature (e.g., from approximately 15 degrees Celsius to approximately 24 degrees Celsius) and pressure (e.g., from approximately 95 kPa to approximately 105 kPa). Printing of the thermoset materials may also be performed at higher temperatures (e.g., temperatures up to 40 degrees Celsius). If the thermoset materials are cooled after extrusion, the resulting target object 102 may be devoid of excessive internal stresses or warping because of the cross-linking of the thermoset materials. The first and second coreactive components may be mixed a short distance prior to the nozzle 124 within the printer head 142, forming the coreactive composition. Alternatively, the first and second components may be mixed in the nozzle 124 immediately before extrusion. The nozzle 124 may comprise a static mixing nozzle or a dynamic mixing nozzle.

The 3D printing design software 108 may also comprise a tool path generation unit 112 for sending commands to the 3D printer 120 for setting the path followed by the nozzle 124 across the platform 122 of the 3D printer 120. The 3D printing design software 108 may also comprise a flow rate processing unit 114 for adjusting the amount and ratio of coreactive components and/or color materials extruded by the 3D printer 120 as well as a dispenser control unit 116 for controlling the type and amount of color material components dispensed by a dispensing machine 130, as described more fully below. Additionally, the 3D printing design software 108 may comprise a color material dataset 118 for maintaining a list of available color materials disposable to the system 100.

The mixed coreactive composition may have a color property, such that the coreactive composition obtains a desired final color property after curing. To obtain the color property, one or more color materials may be mixed with the first and second coreactive components. The thermoset 3D printer 120 or the computer 104 controlling the thermoset printer 120 may receive a color printing data packet that may comprise a three-dimensional attribute including the coordinates corresponding to portions of the platform 122 or underlying layers over which the coreactive composition is to be deposited. The color printing data packet may also comprise an indication of a color attribute including the desired final color property of the target object 102. The color printing data packet may be generated from a computer aided design (CAD) file. The desired final color property of the coreactive composition may be matched to a color property of a reference object 128 or to a color attribute contained within a color attribute dataset. A desired final color property selected by a user may also be considered to match the color property of a reference object 128 if the desired final color property of the target object 102 and the color property of the reference object 128 are considered indistinguishable by the human eye.

The desired final color property of the target object 102 may be input by the user to the computer 104. For example, the user may input to the system 100 the desired final color property of the target object 102. The input of the final desired property of the target object 102 may comprise color formats, including: red, green, blue (RGB) format; pantone matching system (PMS) format; cyan, magenta, yellow (CMY) format; cyan, magenta, yellow, key (CMYK) format; CIELAB format; CIELUV format; hex color values; coded color terms corresponding to color values stored by the system 100; spectral data; or other color formats or models. The desired final color property may be selected from a list or database of available color properties presented to the user by the system 100. The desired final color property may be selected after the user provides an input of one or more associated parameters. For example, the 3D thermoset printer 120 may print a portion of the exterior of a car. The user may input a car year, make, and model, to the system 100 after which the system 100 may provide a list of color properties associated with the model of car for selection by the user. In a similar example, the user may provide a vehicle identification number (VIN) of a car for which a replacement part is to be printed, after which the system 100 may provide the specific one or more color properties associated with the vehicle at the time of manufacture.

In another example, a color chip (i.e., a card having a color property and an associated identification value) may be selected from a color chip collection as having a color property that is close to or indistinguishable from the desired final color property. The color chip collection may contain multiple color chips having different color properties. The color chip may correspond to a color attribute database, such that a user may select the desired final color property within the color attribute database based on association of the selected color chip to a color property within the color attribute database using the associated identification value of the color chip. The color chip may be selected from the color chip collection based on the similarity of the color property of the color chip to the color property of a reference object 128. The color property of the selected color chip may be indistinguishable by the user to the color property of the reference object 128.

The computer system 100 may include a measurement device 126, comprising a spectrophotometer, 3D camera, 2D camera, or other device capable of making color measurements. The measurement device 126 may communicate to the computer 104 the color measurement of a surface of the reference object 128. For example, a color measurement comprising a spectrophotograph may be taken of the surface of a component of the exterior of a vehicle and sent to the computer 104 for generating a print command including a color printing data packet.

The color measurement may be obtained in the same time frame as a print command is sent from the computer 104 to the thermoset 3D printer 120. That is, the color measurement may be sent within a short time period (e.g. within 1 minute) of the color printing data packet being sent to the thermoset 3D printer 120. The color measurement may be collected in the same location as the thermoset 3D printer 120, such that the target object 102 is printed in the vicinity of the reference object 128. The thermoset 3D printer 120 may also deposit a layer of the coreactive composition on the reference object 128 from which the color measurement was taken. The thermoset 3D printer 120 may be connected to one or more color materials. The system 100 may store a list or inventory of color materials connected to the 3D printer 120 or color materials that are available for connecting to the 3D printer 120 within the color material dataset 118. A list or database of available color attributes presented to the user may be limited to color properties associated with color materials in the color material dataset.

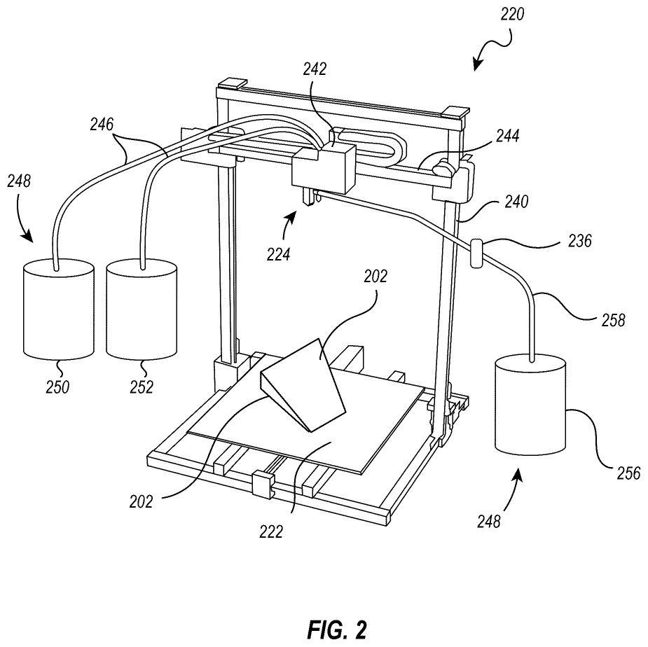

FIG. 2 illustrates a thermoset 3D printer 220 configured to print a target object 202 having a desired final color property. The printer 220 may comprise a platform 222, a frame 240, a printer head 242 comprising a nozzle 224, wherein the nozzle 224 comprises an extruder, diffuser, orifice, or other component for delivering the coreactive composition to the platform 222. The printer 220 may also comprise a gantry 244 upon which the printer head 242 may slide, the gantry 244 being configured to move up and down the frame 240. The frame 240 may also be configured to move across the platform 222. The thermoset 3D printer 220 may be connected via a delivery line 246 to two or more reservoirs 248 configured to store materials for forming the coreactive composition. Each reservoir of the two or more reservoirs 248 may be connected to the printer 220 by a separate delivery line 246. The reservoirs may comprise containers, canisters, jars, tubs, or other storage structures configured to contain thermoset materials and/or color materials. A pump may be disposed between each reservoir 248 and the nozzle 224 for supplying the contents of the reservoir 248 to the nozzle 224. The pump associated with each reservoir may be located within the printer head 242 or may be disposed outside the printer head 242, and may be controlled by the thermoset 3D printer 220 to extrude materials contained in the reservoirs 248.

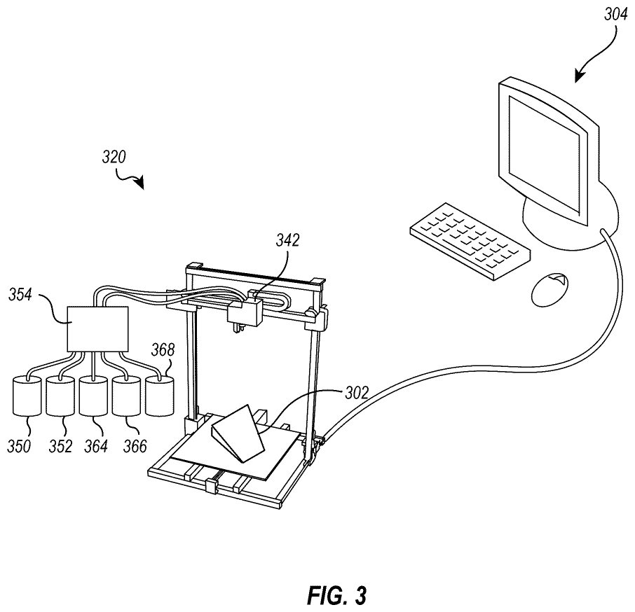

The thermoset 3D printer 220 may be connected to a first reservoir 250 and a second reservoir 252, wherein the first reservoir 250 comprises a first coreactive component and the second reservoir 252 comprises a second coreactive component. The first reservoir 250 and second reservoir 252, comprising the first and second coreactive components, respectively, may each be connected to the printer head 242 via a delivery line 246. As seen in FIG. 3, the first reservoir 350 and second reservoir 352 may be connected to and mixed at a manifold 354 to form a coreactive composition before delivering the coreactive composition to the printer head 342 via one or more delivery lines 346.

The thermoset 3D printer 220 may also be connected to a color reservoir 256 having a color material disposed therein. The color reservoir 256 may comprise a color material configured to provide a desired final color property to the coreactive composition when mixed with the first and second coreactive components. The desired final color property of the coreactive composition may be the same as the desired final color property of the target object 202, or the target object 202 may obtain the desired final color property after curing of the coreactive composition. The color material of the color reservoir 256 may comprise a colorant, one or more pigments, dyes, stains, tints, toner, or other color material components, as described above. The color reservoir 256 may be connected to the thermoset 3D printer 220 via a delivery line 258. The delivery line 258 may connect the color reservoir 256 to the nozzle 224 of the thermoset 3D printer 220, wherein the color material is mixed with the coreactive composition within the nozzle 224. The delivery line 258 may include a valve 236 for purging the delivery line 258 of the color material. The valve 236 may be located as close to the nozzle 224 as is practicable (i.e., a distance sufficient from the nozzle 224 such that the valve 236 does not interfere with the extrusion of the coreactive composition or the surface of the target object 202). For example, the valve 236 may be disposed from the nozzle 224 by approximately 1 inch to approximately 6 inches, or approximately 2 inches to approximately 4 inches, or approximately 3 inches, or by a range having as endpoints any two of the foregoing values. The delivery line 258 may connect the color reservoir 256 to a portion of the printer head 242 other than the nozzle 224. The color material may be mixed with the coreactive composition at the location other than the nozzle 224, such as within the printer head 242. As shown in FIG. 3, the color reservoir, comprising color reservoirs 364, 366, and 368 may be connected to the manifold 354 wherein the one or more color materials are mixed with the first and second coreactive components.

FIG. 3 illustrates a thermoset 3D printer 320 connected to a computer 304 configured to print a target object 302 having a desired final color property. The printer 320 may be connected to a first reservoir 350 having a first coreactive component and a second reservoir 352 having a second coreactive component as well as two or more color reservoirs, such as color reservoirs 364, 366, and 368, connected to the printer head 342 for providing thermoset materials and color materials to the printer 320.

The first and second coreactive components and the color materials disposed in color reservoirs 364, 366, and 368 may be connected to a manifold 354 wherein the coreactive components are mixed to form the coreactive composition and wherein the coreactive composition is delivered to the printer head 342 by a delivery line 346 connecting the manifold 354 to the printer head 342. The viscosity and/or reactive time of the coreactive components may be adjusted by the inclusion of a solvent (such as, but not limited to, a reactive diluent, a resin, or a pigment rheology modifier), or the coreactive components may be substantially free of a solvent or completely free of a solvent. The solvent may be a solid material, such as a resin. Alternatively, the solvent may be a liquid material (i.e., a carrier liquid). The viscosity of the coreactive components (i.e., coreactive materials) may be adjusted by the inclusion of a filler, or the coreactive components may be substantially free of a filler or completely free of a filler. The viscosity of the coreactive components may be adjusted by using components having lower or higher molecular weight. For example, a coreactive component may comprise a prepolymer, a monomer, or a combination of a prepolymer and a monomer. The viscosity of the coreactive components may be adjusted by changing the deposition temperature. The coreactive components may have a viscosity and temperature profile that may be adjusted for the particular deposition method used, such as mixing prior to deposition and/or ink jetting. The viscosity of the color materials may be similarly adjusted as the coreactive components described above. Generally, thermoset materials and color materials will exhibit improved mixing when the materials have similar viscosities. A pump associated with each reservoir connected to the manifold 354 may be disposed within the manifold 354, or may be disposed between each reservoir and the manifold 354, for providing the thermoset materials and color materials in specific amounts or at a specific rate. The first and second coreactive components may also be provided at a specific ratio depending on the desired mechanical properties of the target object 302. Additionally, the first and second coreactive components may be adjusted to compensate for the inclusion of toners, colorants, or other color materials that might otherwise change the mechanical properties of the target object.

Two or more color reservoirs may be connected to the printer 320 to provide multiple distinct color materials having different color properties to the printer 320. The printer 320 may be connected two, three, four, five, or more than five color reservoirs. As shown, two or more color reservoirs may be connected to the manifold 354 to be mixed with the coreactive composition. Alternatively, the two or more color reservoirs may be connected to the nozzle 324 and mixed at the nozzle 324 with the coreactive composition before extrusion through the nozzle 324. The two or more color materials of the two or more reservoirs 348 may be mixed at a specific ratio with the coreactive composition to form the desired final color property.

The thermoset 3D printer 320 may comprise a CMY printer 320. For example, color reservoir 364 may comprise a color material having a cyan (C) color property, color reservoir 366 may comprise a color material having a magenta (M) color property, and color reservoir 368 may comprise a color material having a yellow (Y) color property that may be mixed with the first and second coreactive components to form a coreactive composition with the desired final color property. The thermoset 3D printer 320 may comprise a CMYK printer 320. Similarly, the printer 320 may comprise at least four color reservoirs, each comprising a different color material having one of the following color properties: cyan (C), magenta (M), yellow (Y), and key (K, i.e. black). The printer 320 may combine the four color materials at various ratios to arrive at the desired final color property of the target object 302. In this way, a variety of desired final color properties may be achieved without the need to disconnect and replace color reservoirs. A CMY or CMYK printer may also decrease the amount of color material components that need to be kept on site, as the formulation, dispensing, and mixing of color materials having color properties identical to the desire final color property is reduced. Color materials having different color properties than those associated with the CMY and CMYK printers described above may also be disposed in the two or more color reservoirs for combining in specific ratios to achieve the desired final color property.

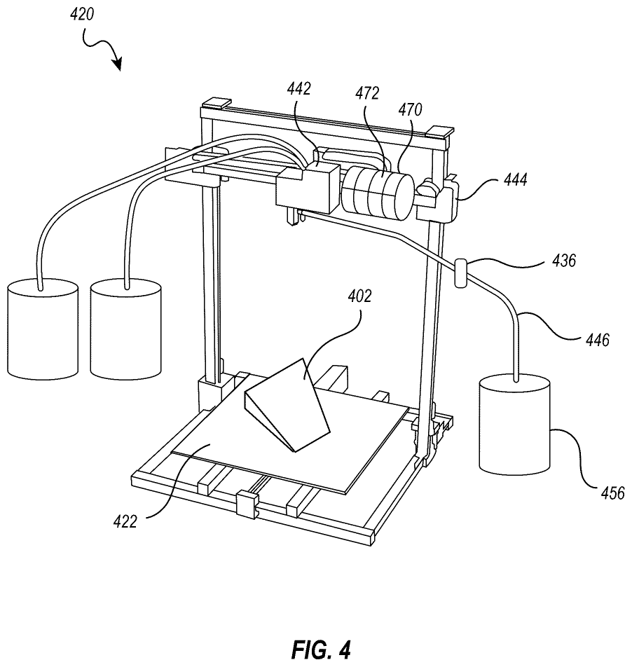

FIG. 4 illustrates a thermoset 3D printer 420 configured to print a target object 402 having a desired final color property, wherein a mounted reservoir 470 is fixed to the arm of the gantry 444. The frame 440 and gantry 444 of the thermoset 3D printer 420 may have a sufficient strength to support the printer head 442 and the mounted reservoir 470. The printer head 442 and mounted reservoir 470, including thermoset and/or color materials, may have a heavy load. For example, the frame 440 and gantry 444 may be sufficiently strong to support a load in a range of approximately 25 pounds to approximately 300 pounds, or approximately 50 pounds to approximately 200 pounds, or approximately 75 pounds to approximately 100 pounds, or a range having as endpoints any two of the foregoing values.

The mounted reservoir 470 may be similar to color reservoirs 256, 456 such that a color material is stored in the mounted reservoir 470. The color reservoirs, including color reservoirs 256, 364, 366, 368, and 456, as well as the mounted reservoir 470 may contain two or more color materials disposed within separate compartments within the reservoir. For example, the mounted reservoir 470 may comprise compartments 472 wherein each compartment 472 contains a separate color material. The mounted reservoir 470 may be configured to provide CMYK color materials, such that a color material having a cyan (C) color property, a color material having a magenta (M) color property, a color material having a yellow (Y) color property, and a color material having a key (K) color property are each stored within a separate compartment 472 of the mounted reservoir 470.

The color material(s) may be formulated, dispensed, and mixed manually by a user. Alternatively, or additionally, the color material(s) may be mixed by a mixing machine. The color material(s) may be formulated by the computer system, such that the computer system provides a formulation or recipe for the color material and wherein the user may combine color material components (e.g., pigments, solvents, fillers, and/or stabilizers) according to the formulation or recipe.

The target object 402 may be formed as the thermoset 3D printer 420 prints multiple layers of coreactive composition on the platform 422. Two layers adjacent to each other may comprise a underlying layer and an overlying layer. The overlying layer may be deposited above the underlying layer. Generally, the target object 402 will be formed one layer at a time, an initial layer being printed on the platform 422, followed by subsequent layers thereafter, such that the overlying layers may bond to the underlying layers before the underlying layer has fully cured.

An underlying layer may comprise a final color property different from a final color property of an overlying layer. The thickness of the layers may be sufficient such that the overlying layer prevents the color property of the underlying layer from being transmitted through the overlying layer. A layer thickness of 0.2 to 0.5 mm has been found to be sufficient to prevent the transmission of the color property of the underlying layer through the overlying layer. The overlying layer may be sufficiently thin to allow the transmission of the color property of the underlying layer through the overlying layer. By so doing, the color property of the layers immediately underlying the surface may contribute to the color appearance of the target object 402. For example, the printed layers may have a thickness in a range of approximately 0.005 mm to less than approximately 0.2 mm, or approximately 0.01 mm to approximately 0.1 mm, or approximately 0.02 mm to approximately 0.05 mm, or a range having any two of the foregoing values as endpoints. The overlying layer may have a thickness greater than 0.2 mm and through which the color property of the underlying layer is perceptible or may be visible. For example, the overlying layer may comprise a coat layer, the coat layer having a small or no amount of pigment and/or the coat layer comprising effect pigments, such that the color property of the underlying layer is visible through the coat layer.

The printer 420 may extrude an overlying layer over a portion of the underlying layer, such that the overlying layer is disposed over and conceals only a portion of the underlying layer. Additionally, the surface of the target object 402 may comprise a first portion and a second portion, the first portion having a first color property different from a second color property of a second portion.

The color property of a layer may change between portions of the layer. The color property of the coreactive composition may be changed by first purging the first color material of a first color reservoir, such as color reservoir 456 from the delivery line 446 (e.g., via the valve 436) and connecting the delivery line 446 to a second color reservoir or by connecting a different delivery line and second color reservoir to the printer 420, the second color reservoir comprising a second color material with a color property different from the first color property of the first color reservoir. The second reservoir may also comprise a color material dispensed by the dispensing machine 130, as disclosed below. The printer 420 may then extrude the coreactive composition over a waste area (referred to as a “purge”) until a coreactive composition having the second color property is detected. The detection of the second color property of the coreactive composition comprising the different color material may be performed manually by a user, such that the user may input to the system when the second color property is observed to be extruded from the printer 420. The detection may alternatively be performed by a measurement instrument disposed over the waste area, such as a spectrophotometer, a camera, or other color detection instrument.

Alternatively, no detection of the second color property may be needed. Two or more color reservoirs, such as color reservoir 456 and mounted reservoir 470, may be connected to the 3D printer 420. A pump associated with each color reservoir may be disposed between each of the color reservoirs and the printer head 442 and may deliver a specific amount or rate of color materials to be mixed with the coreactive composition at a specific ratio. The ratio of color materials delivered from the two or more color reservoirs may be a ratio configured to provide the desired final color property to the coreactive composition. The color property of the coreactive composition may be adjusted by changing the ratio of color materials provided to the coreactive composition from the two or more color reservoirs. Similarly, the color property of the coreactive composition may be adjusted by changing the ratio of color materials provided to the coreactive composition from two or more compartments of a color reservoir, such as compartments 472 of mounted reservoir 470, two or more color materials having different color properties are disposed within the compartments.

The color property of the coreactive composition may be adjusted discreetly such that the color property of the extruded coreactive composition changes abruptly from a first color property to a second color property. The color property of the coreactive composition may also be adjusted continuously by slowly adjusting the ratio of color materials delivered from the two or more color reservoirs, such that the color property of the extruded coreactive composition forms a gradient changing from a first color property to a second color property over the printed layer.

The coreactive composition may have a first color property and may be extruded to the platform 422 to form a perimeter of a layer, or the perimeter or portion of an outer surface of the target object 402. Thereafter, the color property of the coreactive composition have a second color property different from the first color property, the coreactive composition then extruded to the platform 422 to provide a fill for the perimeter of the layer, or to provide a fill for the perimeter or portion of an outer surface of the target object 402. Finally, the coreactive composition having the first color property may be deposited over the fill comprising the second color property so as to cover or conceal the coreactive composition comprising the second color property from view. The second color property may be substantially the same as the color property of a coreactive composition to which no color materials from a color reservoir are added. Thus, because the coreactive composition comprising the second color property is hidden from view, the amount of color materials added to the coreactive composition is reduced and costs related to colorants, pigments, toners and fillers, and other effect pigments is minimized. A first coreactive composition comprising the first color property may be extruded by a first printer head and a second coreactive composition comprising the second color property may be extruded by a second printer head, such that no purging of the delivery line is required during printing of the layer. The printer 420, as well as printers 120, 220, and 320, may include two printer heads, three printer heads, four printer heads, five printer heads, or more than five printer heads. Each printer head of two or more printer heads may be configured to deliver a coreactive composition having a color property different from the color property of the coreactive composition of any other printer head, or may be configured to deliver a coreactive composition having a layer thickness different than the layer thickness of a coreactive composition from any other printer head.

Returning to FIG. 1, the system 100 may comprise a dispensing machine 130 for preparing the color material to be used by the printer 120. The dispensing machine 130 may be configured to dispense color material components according to input provided by a user. The user may provide an input of the type and/or quantity of color material components to be dispensed by the dispensing machine 130. The type and/or quantity of color material components for dispensing may be input by the user according to a formulation or recipe. The dispensing machine 130 may dispense a type and/or quantity of color material components according to a formulation or recipe communicated to the dispensing machine 130 by the computer 104. The formulation or recipe communicated to the dispensing machine 130 may be a formulation or recipe selected by the user. The formulation or recipe communicated to the dispensing machine 130 may be determined based on a spectrophotograph obtained by the measurement device 126 (e.g., a spectrophotometer or 3D camera).

The dispensing machine 130 may dispense the color material components to a color reservoir that may then be disconnected from the dispensing machine 130 and connected to the thermoset 3D printer 120 by a user via a deliver line. Alternatively, and as shown in FIG. 1, the dispensing machine 130 may dispense the color material components to a color reservoir and wherein the color reservoir remains disposed in or connected to the dispensing machine 130 and is also connected to the thermoset 3D printer 120 by a delivery line 134. The delivery line 132 and 134 connecting the thermoset 3D printer 120 to a color reservoir 156 and dispensing machine 130, respectively, may also comprise or be attached to a valves 136 and 138, similar to valve 236 described above for purging the delivery line 258.

The formulation or recipe selected may be limited to the color material components available to the dispensing machine 130. The dispensing machine 130 may select a color material component for dispensing from two or more color material components that are stored in or otherwise available to the dispensing machine 130. The dispensing machine 130 may store a variety of color material components sufficient to create a large variety of color materials, such as 10 color material components, 20 color material components, or more than 20 color material components.

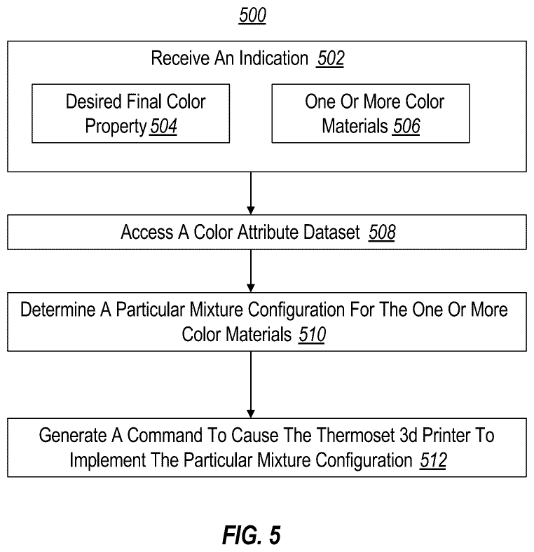

FIG. 5 illustrates a flowchart of a computer-implemented method 500 for dynamically controlling a thermoset 3D printer (e.g., 3D printer 120) to create desired material attributes. The method 500 may be implemented at the computer 104 that is configured to execute the 3D printing design software 108. The method 500 comprises receiving an indication of a desired final color property of a target object to be printed (directly or indirectly from a user, from another computer program, and/or from the 3D printer 120) (step 502). The indication may comprise (1) an indication of a desired final color property of a target object to be printed (512) and (2) an indication of one or more color materials that are available to the thermoset 3D printer (506). In some cases, the indication of a desired final color property of a target object may be received with a color printing data packet. The color printing data packet may be entered by a user and/or generated by another computer program based on the user input. In particular, the indication of the desired final color property of a target object may comprise (but are not limited to) a color property, a three-dimensional property, or other physical property.

The method 500 may also comprise accessing a color attribute dataset (which may correspond to the color material dataset 118 of FIG. 1) (step 508). The color attribute dataset may describe different color properties that result based upon different mixture configurations of the one or more thermoset materials and color materials. The color attribute dataset may also comprise a list of available color materials disposable to the system 100. Based upon the color attribute dataset, a particular mixture configuration for the one or more thermoset materials and color materials is determined in order to achieve the desired final color property of the target object (step 510). Finally, a command is generated to cause the thermoset 3D printer to implement the particular mixture configuration and/or printing configuration of the one or more thermoset materials and color materials when printing the target object (step 512).

The particular mixture configuration may comprise (but are not limited to) (1) which thermoset materials are to be used and/or their specific ratios and (2) which color materials are to be used and/or their specific ratios.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present disclosure may comprise or utilize a special-purpose or general-purpose computer system that comprises computer hardware, such as, for example, one or more processors and system memory, as discussed in greater detail below. Embodiments within the scope of the present disclosure also comprise physical and other computer-readable media for carrying or storing computer-executable instructions and/or data structures. For example, computer-readable media comprising one or more physical computer-readable storage media may store computer-executable instructions that, when executed at a processor, cause a computer system to perform the method 500 described above. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, systems, methods, and apparatuses of the disclosure can comprise at least two distinctly different kinds of computer-readable media: computer storage media and transmission media.

Computer storage media are physical storage media that store computer-executable instructions and/or data structures. Physical storage media comprise computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality.

Transmission media can comprise a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be comprised within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be comprised in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the disclosed systems, methods, and apparatuses may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The systems, methods, and apparatuses may also be practiced in distributed system environments where local and remote computer systems, which are linked (either by hardwired data links, wireless data links, or by a combination of hardwired and wireless data links) through a network, both perform tasks. As such, in a distributed system environment, a computer system may comprise a plurality of constituent computer systems. In a distributed system environment, program modules may be located in both local and remote memory storage devices.

Those skilled in the art will also appreciate that the systems, methods, and apparatuses may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some system environments, such as a cloud-computing environment, may comprise a system that comprises one or more hosts that are each capable of running one or more virtual machines. During operation, virtual machines emulate an operational computing system, supporting an operating system and perhaps one or more other applications as well. Each host may comprise a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource.

Examples of physical resources including processing capacity, memory, disk space, network bandwidth, media drives, and so forth.

The present disclosure is further specified in the following aspects.

Aspect 1: A computer system for dynamically controlling a thermoset three-dimensional printer to create desired color attributes, comprising:
one or more processors; and
one or more computer-readable media having stored thereon executable instructions that when executed by the one or more processors configure the computer system to perform at least the following:
   receive a color printing data packet that comprises an indication of a desired final color property of a target object to be printed;
   access a color attribute dataset, wherein the color attribute dataset describes different color properties that result based upon different mixture configurations or printing configurations;
   based upon the color attribute dataset, determine a particular mixture configuration or printing configuration for one or more color materials in order to achieve the desired final color property of the target object; and
generate a command to cause the thermoset three-dimensional printer to implement the particular mixture configuration or printing configuration of the one or more color materials when printing the target object.

Aspect 2: The computer system of aspect 1, wherein the target object comprises an overlying layer and an underlying layer, and wherein a color property of the overlying layer is different from a color property of the underlying layer.

Aspect 3: The computer system of aspect 2, wherein the overlying layer comprises a color material and the underlying layer does not comprise a color material and wherein the overlying layer conceals at least a portion of the underlying layer.

Aspect 4: The computer system of any of aspects 1 to 3, wherein a surface of the target object comprises a first portion having a first color property and a second portion having a second color property different from the first color property.

Aspect 5: The computer system of any of aspects 1 to 4, wherein the indication of the desired final color property is generated by a measurement of a surface of a reference object by a spectrophotometer or a camera.

Aspect 6: The computer system of any of aspects 1 to 5, wherein the color printing data packet is generated from a computer-aided design (CAD) file that includes both a three-dimensional attribute and a color attribute of the target object.

Aspect 7: The computer system of any of aspects 1 to 6, wherein the mixture configuration or printing configuration comprises a coreactive composition comprising a first coreactive component, a second coreactive component, and at least one color material.

Aspect 8: The computer system of aspect 7, wherein the mixture configuration or printing configuration comprises a specific ratio of the first coreactive component, the second coreactive component, and the at least one color material.

Aspect 9: The computer system of aspect 8, wherein the specific ratio of the first coreactive component, the second coreactive component, and the at least one color material is adjusted to obtain a desired mechanical property of the target object.

Aspect 10: The computer system of any of aspects 7 to 9, wherein the at least one color material is selected from two or more color materials provided by a dispensing machine.

Aspect 11: The computer system of any of aspects 7 to 10, wherein a reservoir comprising the at least one color material is connected to a nozzle of the thermoset three-dimensional printer by a delivery line.

Aspect 12: The computer system of aspect 11, wherein the delivery line of the reservoir comprises a valve for purging the delivery line.

Aspect 13: The computer system of aspects 11 or 12, wherein the reservoir is mounted on a gantry of the thermoset three-dimensional printer.

Aspect 14: The computer system of any of aspects 11 to 13, wherein the reservoir comprises at least two color materials, wherein each color material of the at least two color materials is disposed within a separate compartment of the reservoir.

Aspect 15: The computer system of any of aspects 1 to 14, wherein the mixture configuration or printing configuration includes one or more thermoset materials comprising at least one of polyurea, polyurethane, Michael Addition donor and/or acceptor, polysulfide, polythioether, Epoxy-Amine, Aza Michael Addition donor and/or acceptor, or thiolene.

Aspect 16: A computer-implemented method for dynamically controlling a thermoset three-dimensional printer to create desired color attributes, the computer-implemented method executed on one more processors, the method comprising:
receiving a color printing data packet that comprises an indication of a desired final material property of a target object to be printed;
accessing a color attribute dataset, wherein the color attribute dataset describes different color properties that result based upon different mixture configurations or printing configurations;
based upon the color attribute dataset, determining a particular mixture configuration or printing configuration for one or more color materials in order to achieve the desired final color property of the target object; and
generating a command to cause the thermoset three-dimensional printer to implement the particular mixture configuration or printing configuration of the one or more color materials when printing the target object.

Aspect 17: The computer-implement method of aspect 16, wherein a surface of the target object comprises a first portion having a first color property and a second portion having a second color property different from the first color property.

Aspect 18: The computer-implement method of aspects 16 or 17, wherein the indication of the desired final color property is generated by a measurement of a surface of a reference object by a spectrophotometer or a camera.

Aspect 19: The computer-implement method of any of aspects 16 to 18, wherein the particular mixture configuration or printing configuration includes one or more thermoset materials comprising at least one of polyurea, polyurethane, Michael Addition donor and/or acceptor, polysulfide, polythioether, Epoxy-Amine, Aza Michael Addition donor and/or acceptor, or thiolene.

Aspect 20: A computer-readable media comprising one or more physical computer-readable storage media having stored thereon computer-executable instructions that, when executed at a processor, cause a computer system to perform the following:
receive a color printing data packet that comprises an indication of a desired final color property of a target object to be printed;
access a color attribute dataset, wherein the color attribute dataset describes different color properties that result based upon different mixture configurations or printing configurations;
based upon the color attribute dataset, determine a particular mixture configuration or printing configuration for one or more color materials in order to achieve the desired final color property of the target object; and
generate a command to cause a thermoset three-dimensional printer to implement the particular mixture configuration or printing configuration of the one or more color materials when printing the target object.

Aspect 21: The computer system, computer-implement method or the computer-readable media of any preceding aspect, wherein the mixture configuration comprises a coreactive composition and the coreactive composition comprises a first coreactive component, a second coreactive component, and the one or more color material, and wherein the coreactive composition is used for printing the target object.

Aspect 22: The computer system, computer-implement method or the computer-readable media of any preceding aspect, wherein the mixture configuration comprises a coreactive composition comprising a first coreactive component, a second coreactive component, and at least one color material, wherein the first coreactive component and the second coreactive component are able to react with each other.

Aspect 23: The computer system, computer-implement method or the computer-readable media of any preceding aspect, wherein the printing configuration comprises components of a thermoset 3D printer configured to achieve mixing and/or extruding compositions, and other physical properties of a coreactive composition, including color properties, viscosity, and temperature.

Aspect 24: The computer system, computer-implement method or the computer-readable media of any preceding aspect, wherein the mixture configuration comprises a coreactive composition and the coreactive composition comprises a first coreactive component, a second coreactive component, and the one or more color material, and wherein the coreactive composition is used for printing the target object and the color property of the coreactive composition is adjusted during the printing of the target object.

Aspect 25: The computer system, computer-implement method or the computer-readable media of any preceding aspect, wherein the mixture configuration comprises a coreactive composition and the coreactive composition comprises a first coreactive component, a second coreactive component, and the one or more color material, and wherein the coreactive composition is used for printing the target object and the color property of the coreactive composition is adjusted during the printing of the target object by adjusting a ratio of the first coreactive component, the second coreactive component and the one or more color material.

Aspect 26: The computer system, computer-implement method or the computer-readable media of any preceding aspect, wherein the color property of a layer changes between portions of the layer.

Aspect 27: The computer system, computer-implement method or the computer-readable media of any preceding aspect, wherein the target object comprises an overlying layer and an underlying layer, wherein successive layers coreact to form covalent bonds between the layers.

Aspect 28: The computer system, computer-implement method or the computer-readable media of any preceding aspect, wherein the target object comprises an overlying layer and an underlying layer, and (i) a layer thickness is 0.2 to 0.5 mm, and/or (ii) the layer thickness of the underlying layer is 0.2 to 0.5 mm, and/or (iii) the layer thickness of the overlying layer is 0.2 to 0.5 mm.

Aspect 29: The computer system, computer-implement method or the computer-readable media of any preceding aspect, wherein the mixture configuration comprises a coreactive composition and the coreactive composition comprises a first coreactive component, a second coreactive component, and the one or more color material, and wherein the color property of the coreactive composition is adjusted by changing a ratio of color materials provided to the coreactive composition.

The present disclosure may be embodied in other specific forms without departing from its spirit or essential characteristics. The described systems, methods, and apparatuses are to be considered in all respects only as illustrative and not restrictive. The scope of the disclosure is, therefore, indicated by the appended aspects rather than by the foregoing description. All changes which come within the meaning and range of equivalency of the aspects are to be embraced within their scope.

What is claimed is:

1. A computer system for dynamically controlling a thermoset three-dimensional printer to create desired color attributes, comprising:
one or more processors; and
one or more computer-readable media having stored thereon executable instructions that when executed by the one or more processors configure the computer system to perform at least the following:
receive a color printing data packet that comprises an indication of a desired final color property of a target object to be printed;
access a color attribute dataset, wherein the color attribute dataset describes different color properties that result based upon different mixture configurations or printing configurations;
based upon the color attribute dataset, determine a particular mixture configuration or particular printing configuration for one or more color materials in order to achieve the desired final color property of the target object; and
generate a command to cause the thermoset three-dimensional printer to implement the particular mixture configuration or printing configuration of the one or more color materials when printing the target object.

2. The computer system of claim 1, wherein the target object comprises an overlying layer and an underlying layer, and wherein a color property of the overlying layer is different from a color property of the underlying layer.

3. The computer system of claim 2, wherein the overlying layer comprises a color material and the underlying layer does not comprise a color material and wherein the overlying layer conceals at least a portion of the underlying layer.

4. The computer system of claim 1, wherein a surface of the target object comprises a first portion having a first color property and a second portion having a second color property different from the first color property.

5. The computer system of claim 1, wherein the indication of the desired final color property is generated by a measurement of a surface of a reference object by a spectrophotometer or a camera.

6. The computer system of claim 1, wherein the color printing data packet is generated from a computer-aided design (CAD) file that includes both a three-dimensional attribute and a color attribute of the target object.

7. The computer system of claim 1, wherein the particular mixture configuration or particular printing configuration comprises a coreactive composition comprising a first coreactive component, a second coreactive component, and at least one color material.

8. The computer system of claim 7, wherein the particular mixture configuration or particular printing configuration comprises a specific ratio of the first coreactive component, the second coreactive component, and the at least one color material.

9. The computer system of claim 8, wherein the specific ratio of the first coreactive component, the second coreactive component, and the at least one color material is adjusted to obtain a desired mechanical property of the target object.

10. The computer system of claim 7, wherein the at least one color material is selected from two or more color materials provided by a dispensing machine.

11. The computer system of claim 7, wherein a reservoir comprising the at least one color material is connected to a nozzle of the thermoset three-dimensional printer by a delivery line.

12. The computer system of claim 11, wherein the delivery line of the reservoir comprises a valve for purging the delivery line.

13. The computer system of claim 11, wherein the reservoir is mounted on a gantry of the thermoset three-dimensional printer.

14. The computer system of claim 11, wherein the reservoir comprises at least two color materials, wherein each color material of the at least two color materials is disposed within a separate compartment of the reservoir.

15. The computer system of claim 1, wherein the particular mixture configuration or particular printing configuration includes one or more thermoset materials comprising at least one of polyurea, polyurethane, Michael Addition donor and/or acceptor, polysulfide, polythioether, Epoxy-Amine, Aza Michael Addition donor and/or acceptor, or thiolene.

16. A computer-implemented method for dynamically controlling a thermoset three-dimensional printer to create desired color attributes, the computer-implemented method executed on one more processors, the computer-implemented method comprising:
receiving a color printing data packet that comprises an indication of a desired final material property of a target object to be printed;
accessing a color attribute dataset, wherein the color attribute dataset describes different color properties that result based upon different mixture configurations or printing configurations;
based upon the color attribute dataset, determining a particular mixture configuration or printing configuration for one or more color materials in order to achieve a desired final color property of the target object; and
generating a command to cause the thermoset three-dimensional printer to implement the particular mixture configuration or printing configuration of the one or more color materials when printing the target object.

17. The computer-implemented method of claim 16, wherein a surface of the target object comprises a first portion having a first color property and a second portion having a second color property different from the first color property.

18. The computer-implemented method of claim 16, wherein the indication of the desired final color property is generated by a measurement of a surface of a reference object by a spectrophotometer or a camera.

19. The computer-implemented method of claim 16, wherein the particular mixture configuration or printing configuration includes one or more thermoset materials comprising at least one of polyurea, polyurethane, Michael Addition donor and/or acceptor, polysulfide, polythioether, Epoxy-Amine, Aza Michael Addition donor and/or acceptor, or thiolene.

20. A computer-readable media comprising one or more physical computer-readable storage media having stored thereon computer-executable instructions that, when executed at a processor, cause a computer system to perform the following:
receive a color printing data packet that comprises an indication of a desired final color property of a target object to be printed;
access a color attribute dataset, wherein the color attribute dataset describes different color properties that result based upon different mixture configurations or printing configurations;
based upon the color attribute dataset, determine a particular mixture configuration or printing configuration for one or more color materials in order to achieve the desired final color property of the target object; and
generate a command to cause a thermoset three-dimensional printer to implement the particular mixture configuration or printing configuration of the one or more color materials when printing the target object.
